(19) United States
(12) Patent Application Publication
(10) Pub. No.: US 2025/0231126 A1
(43) Pub. Date: Jul. 17, 2025

(54) COUNTER COUNTERFEIT AND EMBEDDED BARCODE TECHNOLOGY

(71) Applicant: Gold Standard Radiation Detection, Inc., Albuquerque, NM (US)

(72) Inventor: Mark DERZON, Albuquerque, NM (US)

(21) Appl. No.: 19/022,958

(22) Filed: Jan. 15, 2025

Related U.S. Application Data
(60) Provisional application No. 63/620,938, filed on Jan. 15, 2024.

(51) Int. Cl. G01N 23/20025; G06Q 30/018

(52) U.S. Cl. CPC G01N 23/20025; G06Q 30/0185; G01N 2223/104; G01N 2223/413; G01N 2223/501; G01N 2223/643

(57) ABSTRACT

In one or more amendments, an apparatus has an ion source and a sensor. The ion source can send a pulse or a pulse chain of ions to a target to cause the target to emit photons. The sensor can detect photons emitted from the target. The pulse or pulse chain of ions have a 10-500 ns pulse width and a current density between 1-10,000 A/cm².

### CROSS-REFERENCE TO RELATED PATENT APPLICATIONS

This patent application claims priority to U.S. Provisional Patent Application Ser. No. 63/620,938, filed on Jan. 15, 2024 and titled “Counter Counterfeit and Embedded BarCode Technology,” which is incorporated by reference herein.

This patent application mentions and incorporates by reference the following patent applications. U.S. Patent Application Publication Number 2024/0103190, published on Mar. 28, 2024 and titled “Time-resolved Radiation Dose and Health Mapping in Extreme Environments” is incorporated by reference herein. U.S. Patent Application Publication Number 2023/0260737, published on Aug. 17, 2023 and titled “Long Life-Time, Short Pulse, High Current Ion Source and Particle Accelerator” is incorporated by reference herein. International Patent Application Docket No. GSTN-003/01WO, titled “Radiation Powered High Dose Rate, and High Dose Radiation Sensor and System” is incorporated by reference herein. International Patent Application Publication Number WO/2020/107004, published on May 28, 2020 and titled “Radiation Powered High Dose Rate and High Dose Radiation Sensor” is incorporated by reference herein. U.S. Patent Application Docket No. GSTN-014/01US, titled “Stabilized Diode Radiation Source, and Long-Life Rotating Target for High-Power Particle Beams” is incorporated by reference herein.

### FIELD

The disclosure relates to high-speed methods for encoding ions to a target and decoding ions from a target.

### BACKGROUND

Counterfeit materials are prevalent worldwide and prompt a need to detect and distinguish counterfeit materials from non-counterfeit materials. Counterfeit materials can threaten public safety or compromise value. For example, a counterfeit airplane bolt used in the construction of an airplane can fail and threaten the safety of passengers onboard. In another example, a counterfeit computer chip might carry malicious code that can infect and expose a network. Historically, determining the provenance of material was left to experts until maker markers were used to identify a material. Then, governments began printing money using special paper embedded with radio-frequency markers and/or barcodes. Still, global economic losses due to counterfeiting amount to approximately 1.3 T$/year.

PIXE (particle-induced X-ray Emission) is a known and mature technology. Historically in PIXE, focused ion beams (FIB) of various species are used to excite atoms and/or molecules. PIXE spectroscopy can be used to determine the elemental composition as a function of location of a material or a sample. When a material is exposed to an ion beam, atomic interactions occur that give off photon radiation of wavelengths in the x-ray part of the electromagnetic spectrum specific to an element. Depending on the energy of the incident beam the presence and quantity of atomic species can be measured and identified. Known techniques use small (submillimeter beams) at very low currents (picoamps to microamps) and can take several minutes to set up samples and acquire and process the data. Acquiring data for large samples is especially time consuming. For example, the sample in FIG. 23 requires 500 seconds per data point for a beam at 2 nA and total charge 1 uC. The related known equipment is also expensive and application specific. For these reasons, PIXE is normally used in laboratory conditions, rather than industrial settings. See “Instrumentation for PIXE and RBS,” International Atomic Energy Agency (IAEA) TECDOC-1190 December 2000, which is incorporated herein by reference.

At least one known group is pursuing high speed PIXE (HS-PIXE). “A New Particle-Induced X-ray Emission Set-Up for Laterally Resolved Analysis Over Wide Areas”, D. Hanf, et al, Nuclear Instruments and Methods in Physics Research Section B: Beam Interactions with Materials and Atoms 377 (2016): 17-24, which is incorporated herein by reference. This group gets excellent energy resolution over moderate sized areas. It takes them only 45 min. to obtain data on fine-zoned structures of 0.1 atomic percent in Ta—La X ray radiation. The major strength of the system is the ability to simultaneously analyze a large area (12 mm×12 mm).

Notwithstanding the improvements in PIXE technologies, a need still exists for improved high-speed, large-area systems and methods that provide for encoding ions to a target and decoding ions from a target.

### SUMMARY

In one or more embodiments, an apparatus has an ion source and a sensor. The ion source can send a pulse or a pulse chain of ions to a target to cause the target to emit photons. The sensor can detect photons emitted from the target. The pulse or pulse chain of ions have a 10-500 ns pulse width and a current density between 1-10,000 A/cm².

In one or more embodiments, an apparatus has multiple ion sources. Each ion source is uniquely associated with an ion. Each ion source can send pulsed ions to a target to cause ions from the pulsed ions to be embedded in the target. The ions embedded in the target collectively represent a particle-induced X-ray emission (PIXE) signature. The pulsed ions have a 10-500 ns pulse width and a current density between 1-10,000 A/cm².

In some embodiments, a method can include activating an ion source with a predetermined energy, and embedding, using the ion source, ions in a surface of a material to define a multivariable and two-dimensional or three-dimensional identifier. The ions include at least one ion with a first atomic number and at least one ion with a second atomic number. The second atomic number is different from the first atomic number. The first atomic number and the second atomic number collectively are associated with the identifier.

In some embodiments, a method can include sending pulsed ions from an ion source to a target and detecting photons emitted from the target in response to the ions impacting the target. The pulsed ions have a 10-500 ns pulse width and a current density greater than 1 A/cm².

### BRIEF DESCRIPTION OF THE DRAWINGS

FIG. 1 shows a perspective illustration of a parabolic ion source and a sensor, according to an embodiment.

FIG. 2 shows a perspective illustration of a parabolic ion source and a sensor encoding and decoding targets on a conveyor belt, according to an implementation.

FIG. 3 shows a perspective illustration of an annular ion source and a sensor, according to an embodiment.

FIG. 4 shows a perspective illustration of an annular ion source and sensor encoding and decoding targets on a conveyor belt, according to an implementation.

FIG. 5 shows a system illustration including a sensor for characterizing (e.g., encoding) and/or decoding a material, according to an embodiment.

FIG. 6 shows a system illustration including an example imaging system, 1-D sensor according to an embodiment and a 2-D sensor according to another embodiment.

FIG. 7 shows an illustration of a sensor coupled to a framing camera, according to an embodiment.

FIG. 8 shows a system representation for LAIB and HBL, according to an embodiment.

### DETAILED DESCRIPTION

One or more embodiments include or relate to rapidly characterizing a material, and encoding and decoding an identifier to/from a material by an improved ion source and improved sensor. The ion source can be, for example, a large area ion source, generated by a uniform ion source diode (e.g., an applied magnetic field diode). The ion source can be, for example the ion source discussed in U.S. patent application Ser. No. 18/176,567, in U.S. Patent Application Docket No. GSTN-014/01US, and/or CAIS™. The ion source can be manipulated to provide a large area irradiation or length/slit irradiation onto a target at high current density such that a single pulse (also referred to herein as a burst) or a few pulses create a strong x-ray signature. The large area ion source burst defines the high throughput associated with irradiating and/or imaging the target. The ion source can send to a target material, for example, pulsed ions having a 10-500 ns pulse width and a current density between 1-10000 A/cm². The target material in response to the one or more pulsed ions can emit X-rays. The sensor can detect the X-rays, and in some implementations can resolve the location or origin of the X-rays.

In some implementations, the target material can be embedded with ions without any preparation other than providing a surface of the target material. The sensor and a processor can perform non-destructive characterization of the composition of the target material based on the spectral profile of the X-rays in a process herein referred to as Large-Area Ion-Beam analysis or LAIB analysis. In other implementations, a photomask can be disposed between the ion source(s) and the target so that a set of ions sent through the photomask encodes an interference pattern onto the target. The photomask and resulting interference pattern are associated with a unique identifier (also referred to herein as a barcode). In such implementations, the photomask can degrade over time, so that replicating the barcode is more difficult. In such implementations, multiple photomasks can be used to produce unique barcodes for each item. In such implementations, the sensor and a processor can detect and decode the barcode in a process herein referred to as Hidden Barcode Labeling or HBL.

In some implementations, the pulsed ions from ion source(s) are materially different from the target in elemental composition, so that the identifier is distinct from the target substrate. In some implementations, the ion source can be activated with a predetermined energy. In some implementations, one or more ion sources each composed of an ion species (each species having a unique atomic number) can send pulsed ions to be embedded and superimposed at a common location at the target. In some implementations, one or more ion sources can encode the target with a multivariable and one-dimensional, two-dimensional, or three-dimensional ion species identifier. An ion source composed of one ion species can be, for example, a proton source. Ion sources composed of multiple species can be formed from any materials with inner-shell X-ray emission greater than roughly 20 keV (e.g., Cs to Mercury). The sensor can detect the photons emitted from the target at frequencies greater than or equal to 1 MHZ, and can support for example high-speed LAIB and/or high-speed HBL. In some implementations, a gas can be fed through a manifold to define the ions of the one or more ion sources, and an ion beam can be generated using the gas. In some implementations, a coating can cover the identifier to make the identifier more difficult to read by means other than what is disclosed. The coating can be, for example, sub-micron coating(s) of Aluminum or paint. The one or more embodiments can be used, for example, to encode and decode materials with a substantially inimitable barcode at commercial cost, speed, and scale. The barcode can be used to verify the authenticity of a material (e.g., in supply chain verification and management), and reduce counterfeit materials, parts, and assemblies (e.g., in counterfeit detection).

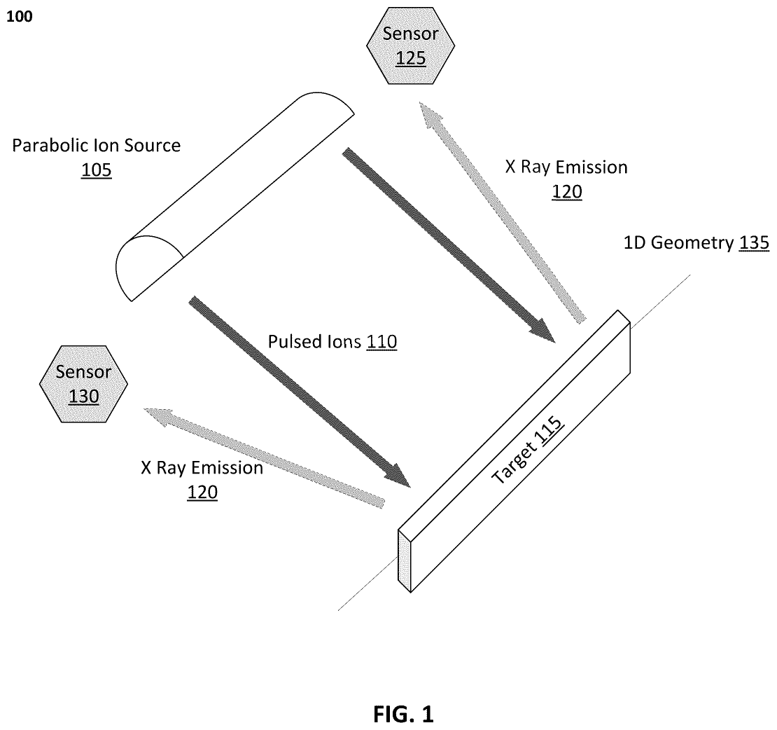

FIG. 1 shows a perspective illustration of a system 100 including a parabolic ion source 105 and sensors 125, 130, according to an embodiment. The parabolic ion source 105 can be a large-area source composed of at least one different atomic number beam species. The sensors 125, 130 can be any sensor suitable for detecting X-rays, such as, for example, commercial framing cameras, scintillators, fibers to streaks, time-integrated sensors, and/or thermopiles. The parabolic ion source 105 can focus pulsed ions 110 to a one-dimensional (1D) geometry (e.g., a line geometry) 135 on a target 115 such that the pulsed ions 110 have a substantially linear beam shape. The pulsed ions 110 embedded in the target 115 collectively represent a particle-induced X-ray emission (PIXE) signature, the signature associated with the elemental composition of a material(s) of the target 115 at the focused geometry 135. The target 115 in response to the pulsed ions 110 can emit X-rays 120. In implementations where a 1D photomask is disposed between the parabolic ion source 105 and the target 115, the signature can be associated with a unique 1D barcode. The sensors 125, 130 can detect the emitted X-rays 120 and characterize the material of the focused geometry 135 outside an outer boundary of the parabolic ion source 105. The embodiment has advantages in signal to noise, speed of access and in some cases a reduced amount of damage to the target and ease of creating an embedded style barcode.

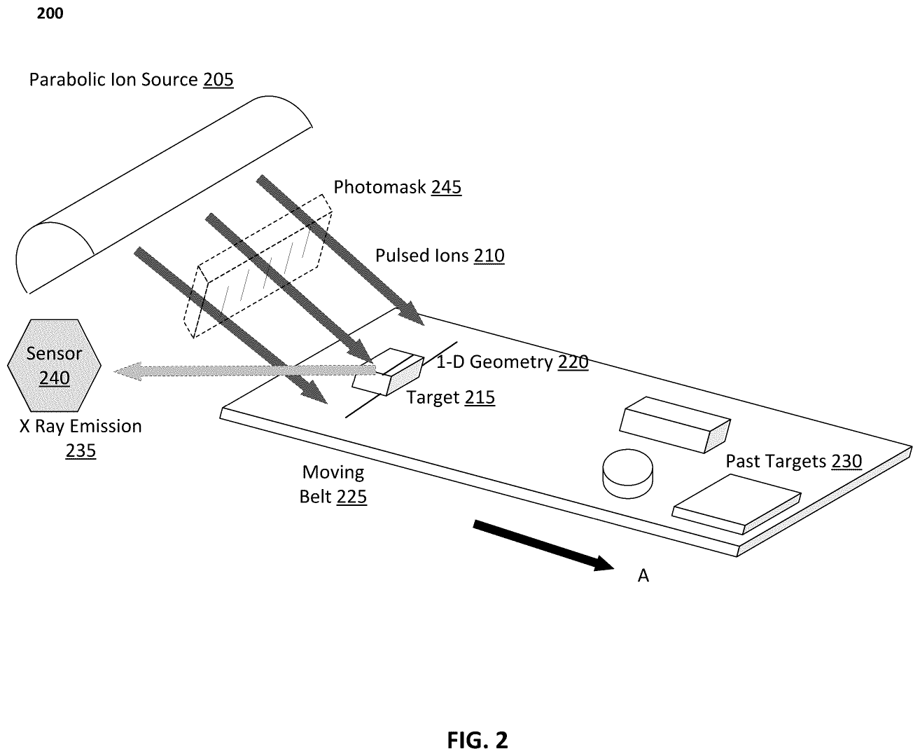

FIG. 2 shows a perspective illustration of a system 200 including a parabolic ion source 205 (e.g., the parabolic ion source 105 of FIG. 1) and sensor(s) 240 (e.g., the sensor(s) 125, 130 of FIG. 1) encoding and decoding targets 215, 230 on a conveyor belt 225, according to an implementation. More specifically, although FIG. 2 illustrates equipment for encoding and decoding targets, it should be understood that the process for encoding targets can be performed during one time period and the process for decoding those targets can be performed during a later time period.

The parabolic ion source 205 and sensor(s) 240 are fixed in place with reference to the conveyor belt 225 that can be moved in direction A. During the encoding process, the parabolic ion source 205 sends the pulsed ions 210 through a photomask 245, a set of the pulsed ions focusing at a 1D geometry 220 on the target 215 and encoding the target 215 with a 1D barcode. In some implementations during the decoding (reading) process, the parabolic ion source 205 sends the pulsed ions 210, causing X-rays to be emitted from the target 215 in response to the pulsed ions 210 impacting the target 215 and to be detected by sensor 240. A processor can receive the output signal from the sensor 240, identify the 1D barcode, and provide an indicator of the ID barcode to a user (e.g., via an output device; not shown). The parabolic ion source 205 and sensor(s) 240 can encode and decode targets 215, 230 at a rate of greater than one targets per minute.

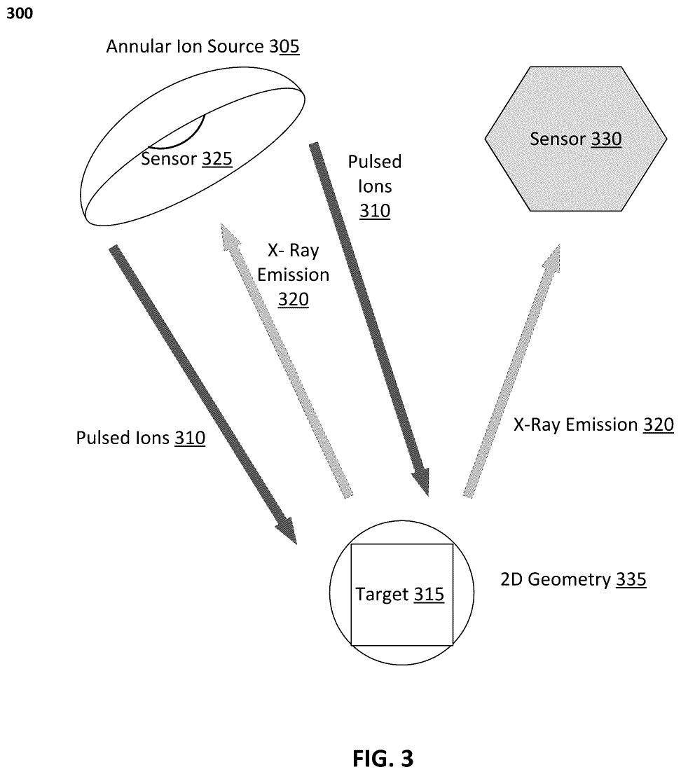

FIG. 3 shows a perspective illustration of a system 300 including an annular ion source 305 and sensors 325, 330, according to an embodiment. Similar to FIG. 2, although FIG. 3 illustrates equipment for encoding and decoding targets, it should be understood that the process for encoding targets can be performed during one time period and the process for decoding those targets can be performed during a later time period.

The annular ion source 305 can be a large-area source composed of at least one of different atomic number beam species. The sensors 125, 130 can be any sensor suitable for detecting X-rays, such as, for example, commercial framing cameras, scintillators, fibers to streaks, time-integrated sensors, and/or thermopiles. The annular ion source 305 can focus pulsed ions 310 to a two-dimensional (2D) geometry (e.g., a circle, rectangle, parallelogram, or other two-dimensional shape) 335 on the target 315 such that the pulsed ions 310 have a substantially circular or annular beam shape. During the encoding process, the pulsed ions 310 embedded in the target 315 collectively represent a particle-induced X-ray emission (PIXE) signature, the signature associated with the elemental composition of a material(s) of the target 315 at the focused geometry 335. In implementations where a 2D photomask (not shown in FIG. 3) is disposed between the annular ion source 305 and the target 315, the signature can be associated with a unique 2D barcode. During the decoding process, the target 315 in response to receiving the pulsed ions 310 can emit X-rays 320. The sensor 325, 330 can detect and decode the emitted X-rays 320. The sensor 325, 330 can have a position either inside an interior of the annular ion source 305 or outside an outer circumference of the annular ion source 305. For example, the sensor 330 can detect the emitted X-rays 320 outside an outer circumference of the annular ion source 305. Such positioning of the sensor 330 can facilitate manufacture of the embodiment. In other implementations, the sensor 325 can detect the emitted X-rays 320 inside an interior of the annular ion source 305. Such positioning of the sensor 325 can improve the field-of-view of the embodiment.

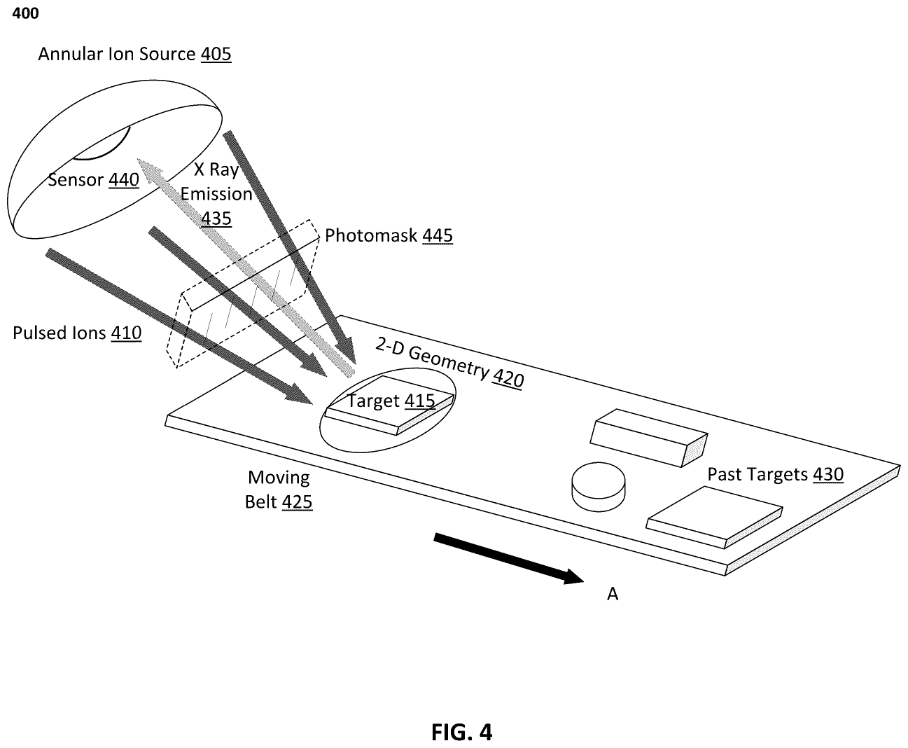

FIG. 4 shows a perspective illustration of a system 400 including an annular ion source (e.g., the annular ion source 305 of FIG. 3) and a sensor (e.g., the sensor 325 of FIG. 3) encoding and decoding targets 415, 430 on a conveyor belt 425, according to an implementation. The annular ion source 405 and sensor 440 are fixed in place with reference to the conveyor belt 425 that can be move in direction A. During the encoding process, the annular ion source 405 sends the pulsed ions 410 through a photomask 445, a set of the pulsed ions focusing at a 2D geometry 420 on the target 415 and encoding the target 415 with a 2D barcode. In some implementations during the decoding process, the annular ion source 405 sends the pulsed ions 410, causing X-rays to be emitted from the target 415 in response to the pulsed ions 410 impacting the target 415 and to be detected by sensor 440. A processor can be configured to receive the output signal from the sensor 440 and identify the 2D barcode embedded in the signal. The annular ion source 405 and sensor 440 can encode and decode targets 415, 430 at a rate of greater than one target per minute.

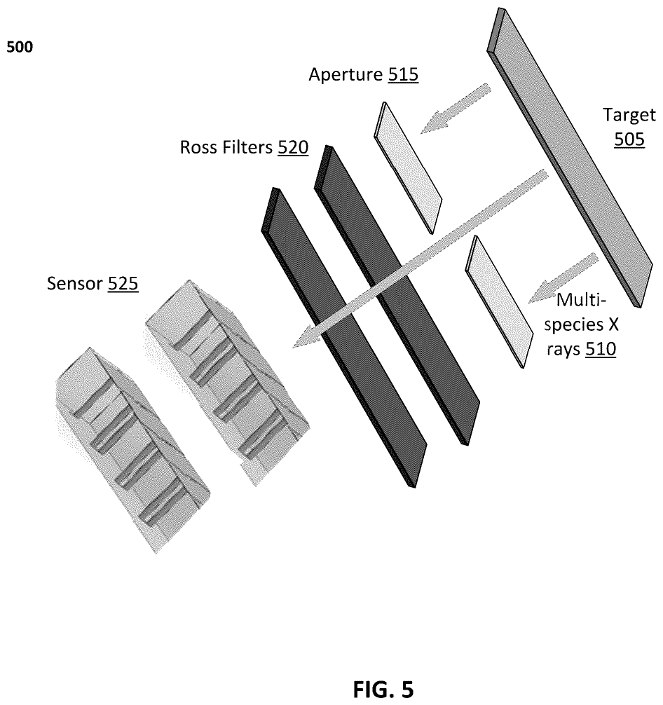

FIG. 5 expands on the decoding process introduced in FIGS. 1-4. More specifically, FIG. 5 shows an illustration of a system 500 including a target 505, a multi-species X-rays 510, an aperture 515, a set of ross filters 520, and a sensor 525, according to an embodiment. Filter sensor combinations can be stacked, meaning they can be layered, but are not shown in the figure. In response to ions from an ion source(s) (e.g., ions from the parabolic ion source 105 in FIG. 1 or ions from the annular ion source 305 in FIG. 3) impacting the target 505, the system 500 can non-destructively characterize a material and/or decode a material associated with an identifier. The system 500 can perform, for example, LAIB and/or HBL. The target 505 can be, for example, a material embedded with a barcode to verify the authenticity of the material. The multi-species X-rays 510 can be X-rays emitted from the material in response to a multi-species ions impacting the material. The aperture 515 can be, for example, a 1D slit or a 2D pinhole, which correspond to a 1D or 2D image, respectively. Implementations that include a 1D slit have faster throughput than implementations that include a 2D pinhole. The set of ross filters 520 can isolate the species of the multi-species X-rays 510 by their energy bands. The sensor 525 can be, for example, a thermopile with a known readout, a fiber-scintillator array, or a thermopile coupled to a framing camera. The sensor 525 can be, for example, a layered and filtered thermopile array that is configured to select specific energy photons. The sensor 525 can be time-resolved, energy-resolved, and spatially-resolved. The sensor 525 can include large area, high energy X-ray dispersive grating dispersed imaging spectrometry of multi-species X-rays. In use, multi-species X-rays 510 emitted from a target 505 pass through an aperture 515, then a set of ross filters 520, until detected by the sensor 525. In some implementations, energy dispersion systems with grating and a variety of other sense elements (such as, for example, traditional framing cameras) can be used instead of ross filters to define a large-area, high-energy X-ray dispersive grating dispersed imaging spectrometer. Dispersed imaging spectrometers have no rate limit. The sensor 525 can then detect each species.

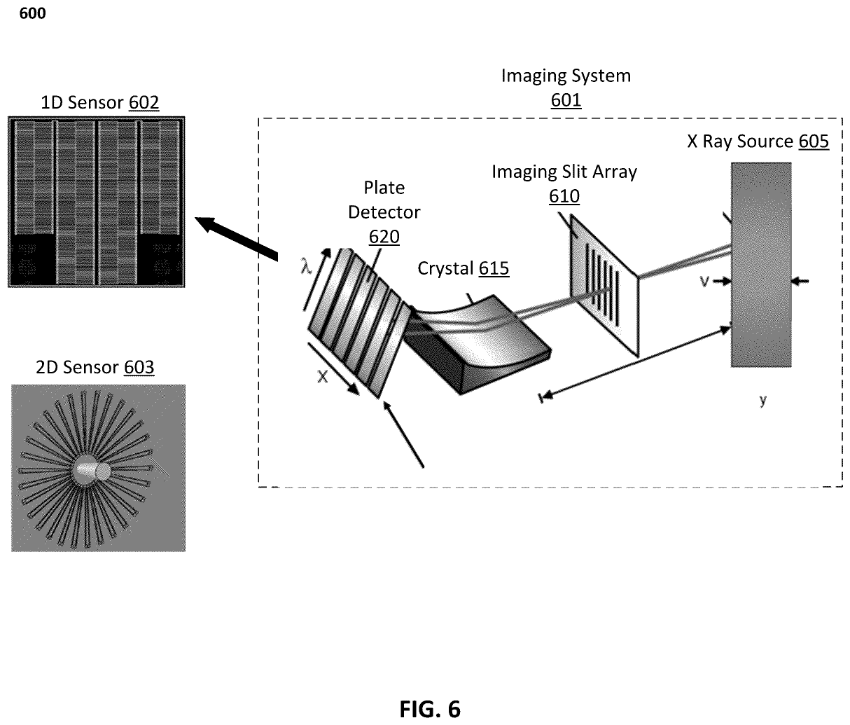

FIG. 6 shows an illustration of a system 600 including an example imaging system 601, a 1D sensor 602 according to an embodiment and a 2D sensor 603 according to another embodiment. The example imaging system 601 includes an X-ray source 605, an imaging slit array 610, a crystal 615, and a plate detector 620. In response to ions from an ion source(s) (e.g., ions from the parabolic ion source 105 in FIG. 1 or ions from the annular ion source 305 in FIG. 3) impacting the X-ray source 605, the system 600 can non-destructively characterize a material and/or decode a material associated with an identifier. The X-ray source 605 can be an imploding z-pinch X-ray source, the ion source, or reflected/induced X-rays from being irradiated with the ion source. The imaging slit array 610 is an aperture that can define the resolution of the plate detector 620. The crystal 615 is elliptically bent and can reflect X-rays to the plate detector 620. The plate detector 620 is a multi-frame, time resolved, microchannel plate detector. The 1D sensor 602 and the 2D sensor 603 can be, for example, the thermopiles discussed in International Patent Application Docket No. GSTN-003/01WO and/or International Patent Application Publication Number WO/2020/017004, each of which is incorporated herein by reference. In the example imaging system 601, the plate detector 620 can for example be substituted with the 1D sensor 602. The 1D sensor 602 can be, for example, a flat thermopile with a massive array of thermocouples.

In a 2D example imaging system (not shown in FIG. 6), an imaging slit array 610 can be substituted with a 2D aperture (e.g., a pinhole with filters) and the plate detector 620 can be substituted with the 2D sensor 603. The 2D sensor 603 can be, for example, a thermopile with thermocouples coupled in series and positioned circumferentially about a center location. Each thermocouple has a hot junction disposed between the center location and a cold junction of that thermocouple. In some implementations, the hot junction has a radiation attenuation greater than one hundred times a radiation attenuation of the cold junction. In some implementations, the 2D sensor 603 has a time resolution in the range of, for example, about 50 picoseconds to 999 milliseconds. In some implementations, the 2D sensor 603 has a shield configured to block background radiation or scattered radiation from the particle source to improve the signal-to-noise ratio of the thermopile's measurement. Because the dispersion determines the energy of the photons, the sensor only needs to integrate the energy deposited and not be energy resolving itself. Although the above discussion of FIG. 6 relates to certain types of example sensors, other implementations can used For example, the thermopile designs discussed in International Patent Application Docket No. GSTN-003/01WO and International Patent Application Publication Number WO/2020/017004, each of which is incorporated herein by reference, with or without hCMOS imaging arrays (standard arrays are acceptable), can be used for performing well calibrated detection.

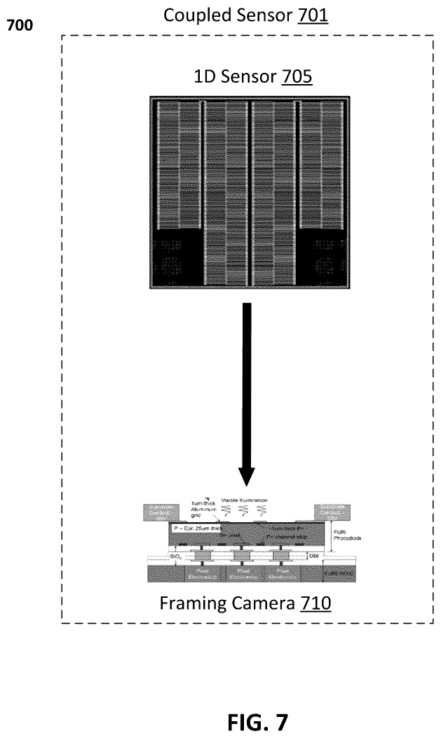

FIG. 7 expands on a sensor that can be used for the decoding process introduced in FIGS. 1-4 and expanded on in FIG. 5. FIG. 7 shows an illustration of a system 700 including a coupled sensor 701, according to an embodiment. The coupled sensor 701 includes a 1D sensor 705 coupled to a framing camera 710. The coupled sensor 701 can be, for example, the sensor 240 of FIG. 2, and/or the sensor 525 of FIG. 5. The coupled sensor 701 can include, for example, a thermopile sensor with a known readout, a thermopile array injection to a solid-state camera readout, a scintillator/gas electron multiplier (GEM) detector, a framing camera, a scintillator bundle/framing or integrating charge-couple device (CCD), Gallium-Arsenide/Silicon/Lutetium-yttrium oxyorthosilicate/Germanium based detector, and/or a calorimeter array. The coupled sensor 701 can be configured to capture a signal from X-rays. The 1D sensor 705 is a flat thermopile array (e.g., the 1D sensor 602 of FIG. 6). The framing camera 710 architecture can be, for example, any one of complementary metal-oxide semiconductor (CMOS), N-channel metal-oxide semiconductor (NMOS), or high-speed complementary metal-oxide semiconductor (hCMOS). The coupled sensor 701 can include pixels, and the pixels can have a well depth indicating the maximum amount of charge that can be held before saturating. The coupled sensor 701 can hold an electric charge of, for example, 1×10¹⁵ Coulombs, or about 6×10³ electrons, which can be a good match for hCMOS well depth. The framing camera 710 can use a wide variety of sensing elements and does not need to be, for example, hCMOS. The framing camera 710 can have a fast and accurate readout of charge per thermocouple and/or thermopile array. Solid-state camera readout can be advantageous for easing calibration and lengthening stability of the coupled sensor 701. The illustration of the system 700 shows the concept for injection of charge to multiple readout systems. In another embodiment, a sensor can include a thermopile array coupled to an infrared (IR) camera, where the infrared camera can have a readout of charge per thermocouple and/or thermopile array.

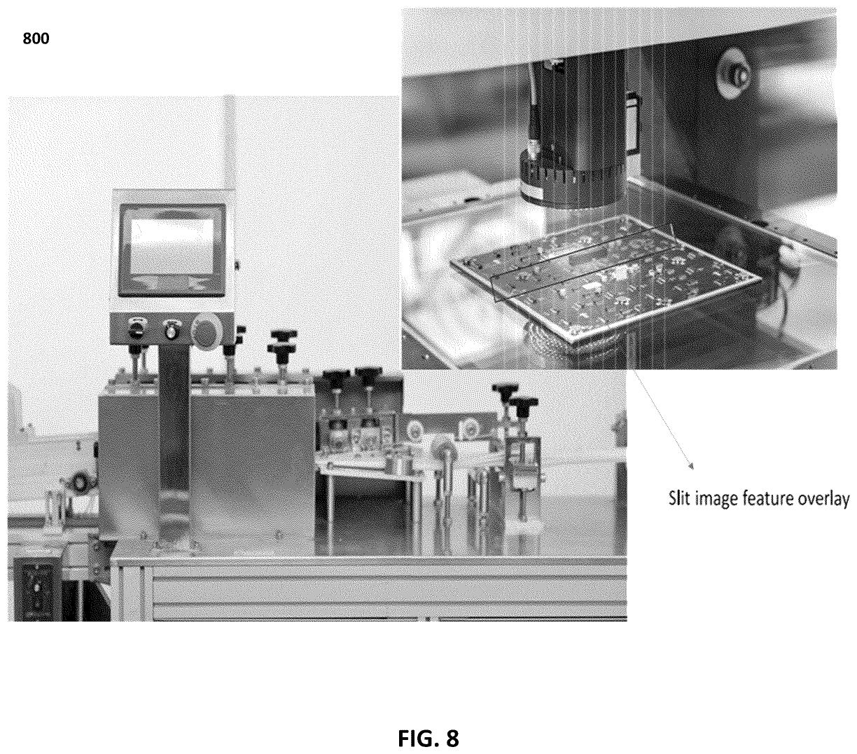

FIG. 8 shows a representation of a system 800 for LAIB and HBL, according to an embodiment. The system 800 for the application of X-rays, ions, or electron beams under fast burst conditions can be much smaller and more compact than many PIXE systems. The system 800 has an order 100 cm² viewing area, a volume for up to a roughly 200J energy storage, a 2-4 MeV endpoint energy, and a modest pulse rate of 1 Hz and order 1 Hz pulse rate. The power supplies data acquisition and processing are located underneath in a cabinet. The area to be studied can be a slit image (to maximize signal-to-noise per pixel) or two-dimensional array. Each pixel along the slit integrates in the direction perpendicular to the slit in the slit imager/spectrometer.

In an embodiment, arbitrarily high gains can theoretically be obtained using the thermopiles described in International Application Publication Number WO/2020/017004, U.S. Patent Application Publication Number 2024/0103190, U.S. Patent Application Publication Number 2023/0260737, and International Patent Application Docket No. GSTN-003/01WO, each of which is incorporated herein by reference. As a practical matter, in this embodiment, gains of, for example, 2-100,000 can be obtained depending on source and target combinations. For example, using thick coatings near 100% solid density for bar-codes can enable vastly reduced ion beam current needs. One or more of the ions sources discussed herein can be made with multiple species (up to Uranium) for multi-species bar-codes. Similarly, several types of sensors are possible. For example, thermopile technologies can offer fast and compact, low-cost options.

In an embodiment, the present disclosure employs a combination of short pulse technology and a novel high dynamic range method for sensing these short bursts of radiation and enhanced target design.

In an embodiment, the present disclosure provides a precise amount of radiation from the source and complete accelerator.

Known PIXE techniques do not use the very high current, high current density large-area pulses, of the ion-diode associated with the one or more embodiments disclosed. The one or more embodiments can more rapidly perform PIXE on large area samples for more industrial purposes, in compact and ultimately much more cost-effective systems. Known systems are not suited to the applications described herein. The explanation above illustrates how these target bar codes can be made. It is by using the beam scribing characteristics of multispecies beams. Reading the barcodes, not just the material in the target component, can be done fast and the equipment can be fast but expensive. The description above also means that a unique bar-code will be exceptionally difficult to fake, particularly if each is unique and the only tie to the source of the barcode is the origination file or document.

The high throughput of such a device makes the cost/test reasonable and for detecting high value materials or parts, the inspection can be very valuable.

Clearly PIXE as a science is well understood, and depending on particle energy the process can work through thin paint and optically thick (meaning visual light blocked) surface coatings. See referenced patents.

In addition, the ion source can embed specific ions into the target material as it is fabricated with a material-based barcode. This is important since, the particle accelerators in current PIXE systems are not cheap and not small, and not easy to use.

Current barcodes are made in two to a few colors. They are generally just black and white and they exist on a surface. They can easily be duplicated. As an additional comparison separate counterfeit or theft protection technology, an RFI chip, which can be duplicated, re-radiates a signature encoded upon it. This is comparatively easy to read but also easy to duplicate. The barcode described in LAIB and HBL can be an alternative to known barcodes and/or RFI chips, in certain situations.

Because the one or more embodiments can read atomic species and image those species rapidly enough to be used in commercial/industrial settings, this is a means to determine provenance and material type (for instance alloy), and if desired a modified version of the ion source can be used to embed atomic species in a pattern that could later be made using the large array PIXE readout concepts. Because the barcode can be made of species unlike and not included in the component to be barcode-marked it can be easy to distinguish the barcode against the underlying substrate.

Known PIXE systems are typically calibrated and used for near surface measurement of very dilute species. Frequently, it is used to diagnose minute amounts of material (down to 1 part per million or ppm). Other bulk x ray spectroscopy is typically used on comparatively macroscopic amounts of material. This invention works in a between regime appropriate for the applications described.

For a thin unknown target:

(M/A)f=(Qs/Q)(y/ys)(M/A)s Fs

where “M/A” is the total mass per unit area; “f’ is the mass fractional content of the particular element to be analyzed; “Q” is the integrated charge in the proton bombardment; “y” is the number of X-ray counts in a peak due to the particular element as measured with a given detector, chamber geometry, and absorber; and “s” denotes the associated quantity for the standard. A thin target is defined as one for which the variations in both X-ray production and self-absorption are negligible over it thickness. The particle source can source enough ions and spread them over a large area to embed a barcode (HBL) or read one coated on a surface at micron scale.

Known systems use optical signatures painted on a surface in various ways. Unlike known signatures which are surface based and relatively easy to measure and reproduce, the optical coatings of the one or more embodiments can be optically thick (opaque) and extremely difficult to fake. In addition, all the reading per article cost can be low.

For example, “PIXE and Its Applications to Elemental Analysis”, by K. Ishii, Quantum Beam Science 3.2 (2019): 12 discloses that a 1 mm² spot with 1 uC or 100 uC/cm² of a 3 MeV proton beam will provide detection limits near 1 ppm (part per million) and take a few minutes. (Table 1 below is based on the assumption that this means 2 minutes). This is a worthwhile metric to compare to performance from the present disclosure.

One or more embodiments include the large area ion source of 10-500 ns temporal width and current densities from 1 to 10,000 A/cm² on target to irradiate the target materials. Performance was scaled linearly to reach 100 ppm, which is adequate for both alloy/part counterfeiting detection of the HBR method of barcoding. The effect is reflected in Table 1, where the scanning effect of the present disclosure shows itself in the time for the operation. The table only contains one comparison. The times reported can vary by changing parameters or systems.

TABLE 1
Compare requirements to current PIXE
performance @100 ppm and 100 cm².

| | Peak Current | | |
|---|---|---|---|
| | Density | Pulse | |
| Method | (uA/cm²) | Width (ns) | Time for 100 cm² |
| Burst | 106 | 100 | 100 ns + processing time |
| LAIB/HBL | | | (estimated seconds) |
| Conventional | | NA | ~30 min + processing time, |
| PIXE | | | See Pallan, XRS, 2017, |
| | | | DOiorg/10.1002/xrs.2779 |

The last column shows relative speed for Burst LAIB/HBL and known PIXE systems at the specified detection level. For higher accuracy, multiple pulses can be used. Roughly 1 ppm can be obtained in 10 s at a 10 Hz pulse rate. Compare the value of current for known PIXE systems and the value for large area; the large area PIXE has an advantage of multiple orders of magnitude in timing. Large areas can be surveyed in seconds using Burst LAIB/HBL compared to minutes or hours using other PIXE technologies.

Known PIXE systems employ on the order ˜30-300 nA/cm². Because the source of Burst LAIB/HBL (the source also discussed in U.S. Patent Application Docket No. GSTN-014/01US) operates at up to 100 million times more current and over a much larger area, it can be much faster. Being faster means that the material to be tested can heat and that the detection schema must be much faster.

Known systems are limited by relatively low-rate detectors (e.g., 5-10 kHz count rates) hence the known long count times to acquire detailed spectra. The detector of Burst LAIB/HBL can go well over 1 MHz in rate, and can accept poorer resolution than most scientific instruments. For the barcode applications the ion sources can use high concentration or solid density materials; even in the alloy or counterfeit materials applications sensitivities to 10,000 ppm are quite adequate. To be complete the technology can go much lower in concentration (2-3 orders of magnitude) with proper design or more pulses and/or more current and the use of grating dispersed spectrometers. These factors can ensure good signal-to-noise in the measurements.

For readout purposes, initially proton beams are the logical choice of beam species. For embedding a barcode multiple materials or atomic number species can be used to generate different x ray energy signatures.

The referenced ion source concepts can generate beams of different materials, multiple beams could also be used to superimpose patterns of a given atomic number species for complex multiplex-ray energy codes. For example, all materials with inner-shell x ray emission greater than roughly 20 keV make excellent choices for the imprinted codes. These range from Cs (at 23 keV) to Mercury). All of these can used in the ion source(s) of Burst LAIB/HDL. Ross filtering can be used to discriminate the energy bands of the different species. Alternatively dispersed grating imaging spectrometers can also be used, these have no limit on rate.

With the bright stable ion source focusable in many ways, embodiments of such systems can use multiple kinds of detectors.

The detector of Burst LAIB/HBL does not count individual events if, for example, the detector was configured to acquire a detailed spectrum in 100 ns. Known PIXE, by comparison, typically counts individual events.

For percent level characterization of a material differential filtering using Ross filter sets is acceptable for the deliberate emplaced bar code reader or high throughput scanning. high energy resolution is not required—to discriminate between k-shell emission in materials from Calcium to Uranium is not difficult.

For the Hidden bar code labeling (HBL), the ion beam can be configured to dope at target, using various ions with a multi-species (for example Zn, W, Hg and Gd) pattern onto manufactured items at microscale. Alternatively, other known methods such as, for example, chemical vapor deposition, physical vapor deposition, or lithography) can be used to create a durable barcode at small scale. A coating(s) of thin layers of various materials can cover the bar codes to hide them from would-be replicators. The coating can be, for example, sub-micron coating of Al, paint, etc. These measures can make it both expensive to duplicate the barcode and difficult to decode the barcode.

The detector embodiments include variants of transmission style time-resolved detection in one or two dimensions or dispersion-based sensor with time, space (1- or 2-dimensions) and energy resolved. Because of the tight timing of the source the detectors will also be time-resolved. The detectors can be, for example, the thermopile arrays discussed in International Application Publication Number WO/2020/107004, U.S. Patent Application Publication Number 2024/0103190, U.S. Patent Application Publication Number 2023/0260737, and International Patent Application Docket No. GSTN-003/01WO, each of which is incorporated herein by reference, the thermopile array melded with hCMOS framing technology, fiber/scintillator coupled bundles, or known silicon imaging sensors in 1-in 2-dimensional arrays.

Spectrometers can be very difficult to absolutely calibrate. By using the thermopile concepts with any of these readouts (for example an hCMOS ROIC), the entire system can be much less expensive to absolutely calibrate.

The drawings primarily are for illustrative purposes and is not intended to limit the scope of the subject matter described herein. The drawing is not necessarily to scale; in some instances, various aspects of the subject matter disclosed herein can be shown exaggerated or enlarged in the drawing to facilitate an understanding of different features.

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a processor, a field programmable gate array (FPGA), and/or an application specific integrated circuit (ASIC). Software modules (executed on hardware) can include instructions stored in a memory that is operably coupled to a processor and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

What is claimed is:

1. A method, comprising:
activating an ion source with a predetermined energy; and
embedding, using the ion source, a plurality of ions in a surface of a material to define a multivariable and two-dimensional or three-dimensional identifier,
the plurality of ions including at least one ion with a first atomic number and at least one ion with a second atomic number different from the first atomic number, the first atomic number and the second atomic number collectively associated with the identifier.

2. The method of claim 1, wherein the embedding is performed at a first time, the method further comprising:
irradiating, using an ion source at a second time, the material to cause x-ray emissions from the material in response to irradiating the material, the x-ray emissions indicative of the multivariable and two-dimensional or three-dimensional identifier; and
performing non-destructive characterization of the material based on the x-ray emissions, the non-destructive characterization associated with at least one of a supply chain verification and management, or a counterfeit detection.

3. The method of claim 1, wherein the embedding is performed without any preparation other than providing the surface.

4. The method of claim 1, wherein the embedding includes sending, using the ion source, a set of ions through a photomask associated with the identifier to cause the surface of the material to be embedded with the set of ions.

5. The method of claim 1, further comprising:
feeding a gas through a manifold to define the plurality of ions; and
generating the plurality of ions using the gas.

6. An apparatus, comprising:
an ion source configured to send to a target a pulse or a pulse chain of ions having a 10-500 ns pulse width and a current density between 1 to 10,000 A/cm² on the target, to cause the target to emit photons in response to the ions impacting the target; and
a sensor configured to detect the photons emitted from the target.

7. The apparatus of claim 6, wherein the sensor includes a thermopile array and a high-speed complementary metal-oxide semiconductor (hCMOS) framing camera having a readout, the hCMOS framing camera is coupled to the thermopile array.

8. The apparatus of claim 6, wherein the sensor is a time-resolved and potentially imaging x-ray spectrometer.

9. The apparatus of claim 6, wherein the sensor includes a thermopile array configured to utilize a solid state camera readout and configured to capture a signal from x-rays.

10. The apparatus of claim 6, wherein the sensor includes a thermopile array and a solid-state camera having a readout coupled to the thermopile array.

11. The apparatus of claim 6, wherein the sensor includes (1) a layered and filter thermopile array that is configured to select specific energy photons, and (2) a x-ray dispersive grating dispersed imaging spectrometer coupled to the layered and filtered thermopile array.

12. The apparatus of claim 6, wherein:
the ion source is configured to send the pulsed ions in a substantially circular or annular beam shape,
the sensor disposed relative to the ion source to be outside an outer circumference of the substantially circular or annular beam shape when the ion source is operative.

13. The apparatus of claim 6, wherein:
the ion source is configured to send the pulsed ions in a substantially linear beam shape,
the sensor disposed relative to the ion source to be outside an outer boundary of the substantially linear beam shape when the ion source is operative.

14. An apparatus, comprising:
a plurality of ion sources,
each ion source from the plurality of ion sources uniquely associated with a ion from a plurality of ions, each ion source from the plurality of ion sources configured to send to a target pulsed ions having a 10-500 ns pulse width and a current density between 1 to 10,000 A/cm² on the target, to cause ions from the pulsed ions for that ion source to be embedded in the target,
the ions embedded in the target collectively representing a particle-induced X-ray emission (PIXE) signature.

15. The apparatus of claim 14, wherein each ion source from the plurality of ion sources are uniquely associated with a material from a plurality of materials having an inner-shell X-ray emission greater than about 20 keV.

16. The apparatus of claim 14, wherein each ion source from the plurality of ion sources is configured to send to the target the pulsed ions to cause ions from the pulsed ions for that ion source to be embedded and superimposed at a common location in the target.

17. The apparatus of claim 14, wherein the plurality of ion sources are configured to send the pulsed ions through a photomask that is associated with an identifier and that is disposed between the plurality of ion sources and the target.

18. The apparatus of claim 14, wherein the target is formed from a plurality of materials, the plurality of ion sources is formed from a plurality of materials different from the plurality of materials of the target.

19. A method, comprising:
sending, from an ion source and to a target, pulsed ions having a 10-500 ns pulse width and a current density greater than 1 A/cm² on the target; and
detecting photons emitted from the target in response to the ions impacting the target.

20. The method of claim 19, wherein:
the ion source is configured to send a set of ions through a photomask that is associated with an identifier and that is disposed between the ion source and the target;
the target is embedded with the set of ions, the method further comprising:
producing an output signal based on the detected photons and associated with the set of ions,
identifying the identifier based on the output signal.
